(19) United States
(12) Patent Application Publication
(10) Pub. No.: US 2002/0091947 A1
(43) Pub. Date: Jul. 11, 2002

(54) Apparatus and method for controlling levels of access permission

(75) Inventor: Katsutoshi Nakamura, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/027,233

(22) Filed: Dec. 27, 2001

(30) Foreign Application Priority Data
Dec. 27, 2000 (JP) 2000-397129

(51) Int. Cl. H04L 9/00; H04L 9/32; G06F 11/30; G06F 12/14

(52) U.S. Cl. 713/202

(57) ABSTRACT

Plural levels of access permission that define limits of information or processing environments available are controlled properly for each user. In a processing environment providing system, an access permission level control unit compares a preassigned priority count with the number of accesses cumulatively stored in a database after a password has been changed. If the number of accesses after the change in password exceeds the priority count, a user operating a corresponding terminal is urged to change the current password. When the password is changed, the preassigned level of access permission is notified to an environment providing control unit. When the password is not changed, a level of access permission that defines narrower limits of a processing environment to be provided is notified to the environment providing control unit. The environment providing control unit provides a processing environment to the terminal according to the level notified.

### CROSS-REFERENCE TO RELATED APPLICATIONS

This application is based upon and claims the benefit of priority from the prior Japanese Patent Application No. 2000-397129, filed Dec. 27, 2000), the entire contents of which are incorporated herein by reference.

### BACKGROUND OF THE INVENTION

1. Field of the Invention

The present invention relates to an apparatus and method applicable to a system for providing service to the user such as the provision of information. In particular, it relates to an apparatus and method applicable to a system for providing service according to levels of access permission that define limits of information or the like to be provided.

2. Description of the Related Art

Such a service that information on target products and relevant information are provided over a communication network to an indefinite number of users has conventionally been offered for the purpose of sales promotion and advertising of the products. Lately, service providers (hereinafter called “operators”) have set up home pages, issued IDs to users who were eligible to become members, and provided service to the members within fixed limits. In the provision of service, the members are given access rights higher in level than nonmembers so that the operators can make a distinction of service between the members and nonmembers.

Further, many operators preassign each member any of two or more levels of access permission that define limits of information available for each user to provide information according to the level of access permission. For example, control is performed according to the level of access permission to determine what level of information inserted in a home page step by step should be provided to an accessing member.

In many cases, the operator's side requires each user to give user's personal information so as to gain membership. However, since most users are reluctant to give their personal information, too many requirements for personal information may discourage the users from applying for membership. Therefore, the operator's side has to set appropriate common ground between the amount of personal information and the quality of service even though they know that more personal information brings the provision of more precise service to each user.

Further, there exist good members who frequently access the service and members who rarely access the service, but the operator's side has no other choice but to provide the same service regardless of the need to make a distinction of information between both. Although long-term members or members who frequently access the service may be given preferential or premium service treatment by using a cumulative history system or a so-called point system, the above-mentioned conventional form of service cannot realize such a premium service system.

Recently, other forms of service have also offered to meet the needs of members, such as to give permission to access or use peripheral equipment on the operator's side or provide a program to add a specific function to a member's terminal. These forms of service, however, have the same problems as the above-mentioned form of providing information.

Further, the provision of service to an indefinite number of users needs to ensure the confidentiality of information or so-called information security.

### SUMMARY OF THE INVENTION

In view of the circumstances, the present invention has been made to wrestle with the problem of how to provide a technique for providing service to each user within appropriate limits. In other words, it is an object of the present invention to provide an apparatus and method for properly controlling plural levels of access permission that define limits of a service object to be provided for each user.

According to the present invention, there is provided an apparatus and method for properly controlling plural levels of access permission that define limits of a service object to be provided to each user.

In attaining the above-mentioned object and according to the present invention, there is provided a first method of controlling levels of access permission. The first control method is implemented in a system in which any of plural levels of access permission that define limits of information available is assigned to each user so that when a user authorized to have access makes a request for the access, the user is permitted to access information within the limits of the access permission level. The first control method comprises the steps of: detecting, on the basis of user's history of access requests, the extent of user's interest in the information to be provided and/or changes in the interest; and allowing the level of access permission currently assigned to the user to be changed to another level according to the detected extent of user's interest and/or changes in the interest. According to the first control method, the levels of access permission can be controlled to provide information to users within appropriate limits. The information to be provided includes information related to products which an information provider aims for sales promotion and advertising.

According to the present invention, there is also provided a second method of controlling levels of access permission. The second control method is implemented in a system in which any of plural levels of access permission that define limits of one or more apparatuses available is assigned to each user so that when a user authorized to have access makes a request for the access, the user is permitted to use the one or more apparatuses within the limits of the access permission level. The second control method comprises the steps of: detecting, on the basis of user's history of access requests, the extent of user's interest in the one or more apparatuses to be used and/or changes in the interest; and allowing the level of access permission currently assigned to the user to be changed to another level according to the detected extent of user's interest and/or changes in the interest. According to the second control method, the levels of access permission can be controlled to allow users to use the one or more apparatuses within appropriate limits. The one or more apparatuses include a printer and a mass storage device.

According to the present invention, there is further provided a third method of controlling levels of access permission. The third control method is implemented in a computer system for providing digital information to add a processing function as needed to a terminal operated by a user, in which any of plural levels of access permission that define limits of digital information accessible is assigned to each user so that when a user authorized to have access makes a request for the access, the user is permitted to access digital information within the limits of the access permission level. The third control method comprises the steps of: detecting, on the basis of user's history of access requests, the extent of user's interest in the digital information to be provided and/or changes in the interest; and allowing the level of access permission currently assigned to the user to be changed to another level according to the detected extent of user's interest and/or changes in the interest. According to the third control method, the levels of access permission can be controlled to provide digital information to users within appropriate limits. The digital information to be provided includes a program executable on a terminal or computer at the information destination.

The above-mentioned first to third method of controlling levels of access permission may further comprise the steps of: holding identification information settable by each user for identifying the user; and asking (urging) the user as the source of an access request to input the identification information so as to define such a permission condition that the user is normally identified using the identification information. In such a control method, the detection step may detect the extent of user's interest and/or changes in the interest on the basis of user's history after the last setting of the identification information.

The control method of controlling levels of access permission may further comprise the step of asking (urging) the user as the source of the access request to update the identification information when the detected extent of user's interest and/or changes in the interest meet predetermined conditions, or when the detected extent of user's interest and/or changes in the interest show that the number of times access is requested exceeds a predetermined number of times.

The above-mentioned method may further comprise the step of changing the level of access permission currently assigned to the user as the source of the access request to a level narrower in scope than that defined by the current level when the identification information has not been updated.

Alternatively, the above-mentioned first to third methods of controlling levels of access permission may further comprise the steps of: assigning each user, in exchange for entries of information related to the user, identification information for identifying the user and a level of access permission defined according to the contents of the information entered; and asking (urging) the user as the source of an access request to input the identification information assigned so as to define an access condition that the user is normally identified using the input identification information. In such a control method, the detection step may detect the extent of user's interest and/or changes in the interest on the basis of user's history after the last setting of the identification information.

The control method may further comprise the step of asking (urging) the user as the source of the access request to enter user's information again when the detected extent of user's interest and/or changes in the interest meet predetermined conditions, or when the detected extent of user's interest and/or changes in the interest show that a predetermined number of days have elapsed since the last access request.

The above-mentioned method may further comprise the step of changing the level of access permission currently assigned to the user as the source of the access request to a level narrower in scope than that defined by the current level, or the step of deleting the identification information assigned to the user when the user has not entered user's information in response to the step of asking (urging) the user to enter the information again.

According to the present invention, there is provided a first apparatus for controlling levels of access permission. The first control apparatus is applied to a computer system in which any of plural levels of access permission that define limits of information available is assigned to each user so that when a user authorized to have access makes a request for the access, the user is permitted to access information within the limits of the access permission level. The first control apparatus comprises: means for monitoring, on the basis of user's history of access requests, the extent of user's interest in the information to be provided and/or changes in the interest, and means for allowing the level of access permission currently assigned to the user to be changed to another level according to the detected extent of user's interest and/or changes in the interest.

According to the present invention, there is also provided a second apparatus for controlling levels of access permission. The second control apparatus is applied to a computer system in which any of plural levels of access permission that define limits of one or more apparatuses available is assigned to each user so that when a user authorized to have access makes a request for the access, the user is permitted to use the one or more apparatuses within the limits of the access permission level. The second control apparatus comprises: means for monitoring, on the basis of user's history of access requests, the extent of user's interest in the one or more apparatuses to be used and/or changes in the interest; and means for allowing the level of access permission currently assigned to the user to be changed to another level according to the detected extent of user's interest and/or changes in the interest.

According to the present invention, there is further provided a third apparatus for controlling levels of access permission. The third control apparatus is applied to a computer system for providing digital information to add a processing function as needed to a terminal operated by a user, in which any of plural levels of access permission that define limits of digital information available is assigned to each user so that when a user authorized to have access makes a request for the access, the user is permitted to access digital information within the limits of the access permission level. The third control apparatus comprises: means for monitoring, on the basis of user's history of access requests, the extent of user's interest in the digital information to be provided and/or changes in the interest; and means for allowing the level of access permission currently assigned to the user to be changed to another level according to the detected extent of user's interest and/or changes in the interest.

In the above-mentioned methods and apparatuses, users of an operator who operates service by providing service objects includes both of members and nonmembers between which a distinction of service is made.

### BRIEF DESCRIPTION OF THE DRAWINGS

These objects and other objects and advantages of the present invention will become more apparent upon reading of the following detailed description and the accompanying drawings in which:

FIG. 1 is a block diagram showing a configuration of an embodiment (first embodiment) of a processing environment providing system to which the present invention is applied;

FIG. 2 shows an example of an ID table stored in an ID database of the processing environment providing system;

FIG. 3 is a flowchart for explaining processing steps after a user login to the processing environment providing system is accepted;

FIG. 4 shows an example of a screen to be displayed on a terminal operated by a user at the time of login;

FIG. 5 shows an example of a screen to be displayed on a terminal operated by a user who is required to change his or her password;

FIG. 6 shows an example of an ID table updated when the user has acceded to the password change request;

FIG. 7 shows an example of an ID table updated when the user has not acceded to the password change request;

FIG. 8 is a block diagram showing a configuration of another embodiment (second embodiment) of an information providing system to which the present invention is applied;

FIG. 9 shows an example of an ID table stored in an ID database of the information providing system;

FIG. 10 shows an example of a screen to be displayed on a terminal operated by a user in response to an information request from the user;

FIG. 11 shows an example of an ID table updated when the user wanted to get an ID only according to the screen example of FIG. 10;

FIG. 12 shows an example of an ID table updated when the user has wanted to get an ID by entering his or her name and telephone number according to the screen example of FIG. 10;

FIG. 13 is a flowchart for explaining processing which the information providing system 4 performs in response to access from the user who already has his or her ID or the user who does not want to get an ID;

FIG. 14 is a flowchart for explaining processing which the information providing system performs in response to access from the user who already has his or her ID or the user who does not want to get an ID; and

FIG. 15 shows an example of a screen to be displayed on a terminal operated by a user in the case the period of time that has elapsed between the last and current accesses exceeds a period defined according to the user's priority level in the flowcharts of FIGS. 13 and 14.

### DESCRIPTION OF THE PREFERRED EMBODIMENTS

<First Embodiment>

Hereinbelow, description will be made about a processing environment providing system to which the present invention is applied.

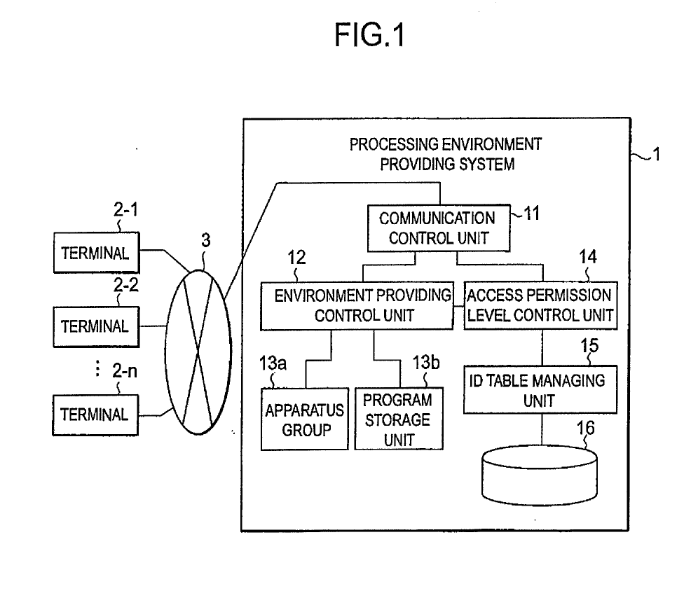

FIG. 1 shows a form of a processing environment providing system 1 to which the present invention is applied. In this form, the processing environment providing system 1 provides processing environments through a network 3 to terminals 2-1 to 2-n operated by users (where n is a real number, and the suffix is omitted below). The processing environment to be provided to each terminal is such an environment as to allow use of one or more apparatuses provided in the processing environment providing system 1 or such an environment as to add a processing function to the terminal by downloading and executing software (digital information). The one or more apparatuses include a mass storage device and a large-format printer. In other words, the processing environment providing system 1 is to build a processing environment for the accessing terminal 2 via software or hardware.

The processing environment providing system 1 includes a communication control unit 11, an environment providing control unit 12, an apparatus group 13a, a program storage unit 13b, an access permission level control unit 14, an ID table managing unit 15 and an ID database 16.

The communication control unit 11 controls the exchange of information with the terminals 2 through the network 3. In other words, the communication control unit 11 sends received information to the access permission level control unit 14 as required and controls communication between the terminals and the environment providing control unit 12. The environment providing control unit 12 controls connection and distribution between the terminals 2 and the apparatus group 13a or program storage unit 13b. In this operation, the environment providing control unit 12 receives the level of access permission defined for each user from the access permission level control unit 14. Then the environment providing control unit 12 gives permission of the connection and distribution according to the level of access permission.

The apparatus group 13a is constituted of various hardware apparatuses such as the mass storage device and the large-format printer. The program storage unit 13b stores software for adding processing functions to the terminals 2. The software includes a program for enabling specific language processing and a specific development tool.

The access permission level control unit 14 controls a level of access permission indicative of a processing environment available to each user (member or nonmember) according to the extent of user's interest in the processing environment to be provided and/or changes in the interest. In the first embodiment, the level of access permission corresponds to a “shell.” The term “shell” is a kind of program (module) that defines in what operating environment a user can perform processing on a terminal 2 when logging in to a UNIX-based system. Further, in the first embodiment, the number of times user's password is changed, corresponding to the number of accesses, is used as information for detecting the extent of user's interest and/or changes in the interest.

The ID table managing unit 15 performs the reading and writing of data from and to an ID table stored in the ID database 16. The ID database 16 holds the ID table in which information such as a password, the number of accesses and a shell is stored for each user. Each terminal 2 may be a general-purpose computer, and the network 3 is a communication network such as a LAN (local area network).

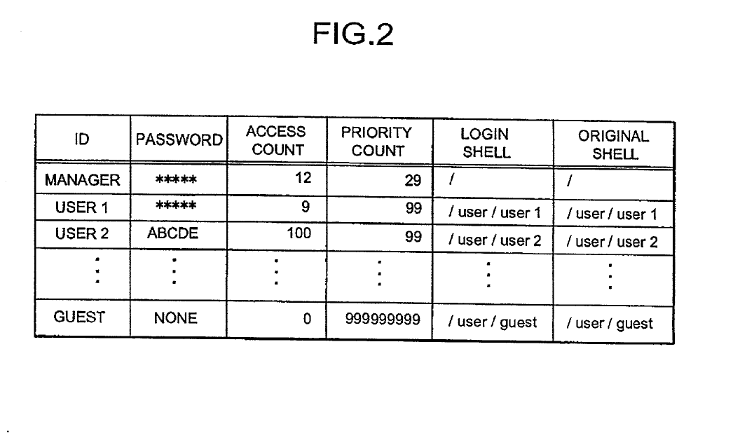

Referring next to FIG. 2, an example of the ID table stored in the ID database 16 will be described.

The term “ID” is information indicative of each user including a manager and a guest to which the shell narrowest in processing environment is assigned. The “Password” is used for recognizing a corresponding ID; it can be set or changed on user's own initiative. The “Access Count” represents the number of times per ID that the user concerned has logged in to the processing environment providing system 1 since user's password was set or changed. The access count is reset each time the password is changed.

The “Priority Count” is information for use in judging a request for changing a password. In the first embodiment, frequencies of judging that the password should be changed are set once every 30 times for the system manager who needs to change his password most frequently and once every 100 times for common users. This is because the system manager usually uses a shell wider in processing environment than the common users. Such a setting can improve security. It should also be noted that only the system manager can change his priority count.

The “Login Shell” represents the position of a directory in which a shell to be executed immediately after each user has logged in is stored. In the first embodiment, if a request for changing a password from a user does not meet predetermined requirements, the same login shell as for the guest is set for the user, which puts restrictions on the user-specific processing environment to be described later.

The “Original Shell” is set for each user, representing the position of a directory in which a shell to be originally executed for the user concerned. In the first embodiment, the system manager can set the original shell at the time of user registration.

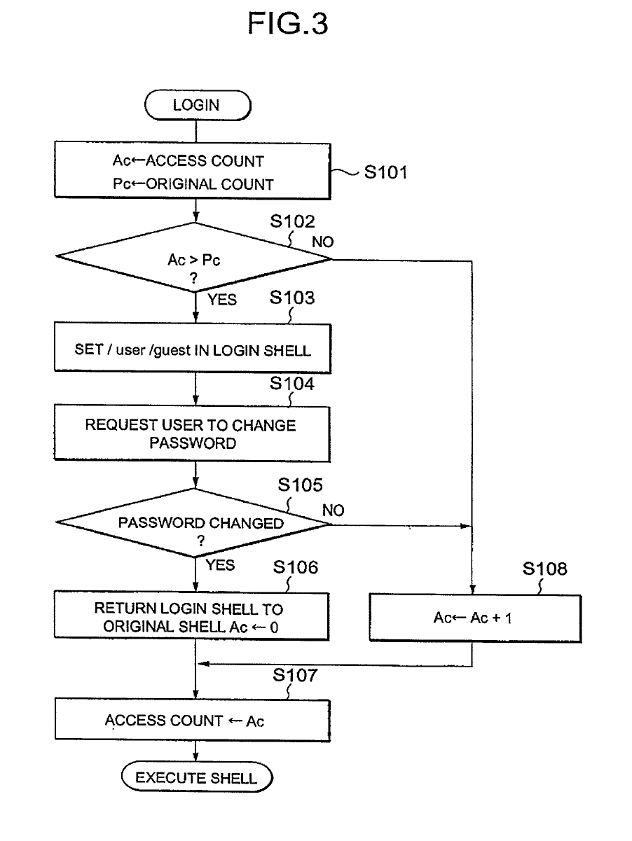

Referring next to FIGS. 3 to 7, description will be made about the operation from the time a user login is accepted until a shell corresponding to the user is executed.

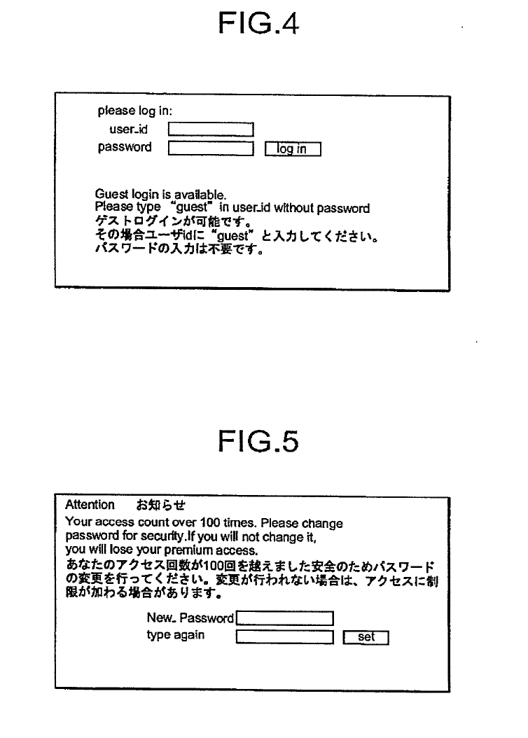

Upon receipt of access from the user through the communication control unit 11, the access permission level control unit 14 sends out information necessary to display a login screen as shown in FIG. 4 on a terminal 2 operated by the user. When an ID and a password are entered on the terminal 2 according to the instructions on the screen displayed, the information is send to the processing environment providing system 1. Upon receipt of the information, the access permission level control unit 14 checks the ID and password to determine whether the user is already registered. If it is checked that the user is already registered, the access count and priority count registered in the ID table are read out and substituted for variables Ac and Pc, respectively (step S101). The access permission level control unit 14 then compares the variables to judge whether Ac exceeds Pc (step S102).

If Ac exceeds Pc (YES in step S102), the ID table is so updated that a login shell corresponding to the accessing user becomes “/user/guest.” After that, the access permission level control unit 14 sends out information so that a screen as shown in FIG. 5 will be displayed on the terminal 2 operated by the user. Thus the user is requested to change the password (step S104).

When the user has changed the password according to the instructions on the screen (YES in step S105), the ID table is so updated that the login shell corresponds to the original shell, and zero is substituted for Ac (step S106). After that, the ID table is so updated that the value, Ac is reflected in the ID table, and the login shell of the accessing user is executed (step S107).

If Ac does not exceed Pc (NO in step S102), that is, when the access count does not exceed the priority count, the value, Ac is incremented by one (step S108). Further, when the user has not acceded to the request for changing the password in step S104 (NO in step S105), the same processing as in step S108 is executed. In either case, the ID table is so updated that the changed value, Ac is reflected in the ID table, and the login of the accessing user is executed (step S107).

FIG. 7 shows an example of the ID table updated when the user has not acceded to the request for changing the password. As shown, for the user having an ID, User 2, the login shell is updated to “/user/guest” without changing the password.

The access permission level control unit 14 performs the above-mentioned processing to control the access permission level (shell). Especially, the user who has not changed the password despite the fact that the user was requested to change the password is assigned the same shell as the guest. In other words, the user is assigned a shell narrower in processing environment than the shell to be originally assigned to the user. Such a loss of premium access makes the user become security conscious and asks (urges) the same to change his or her password more frequently than predetermined frequency set for a predetermined number of accesses.

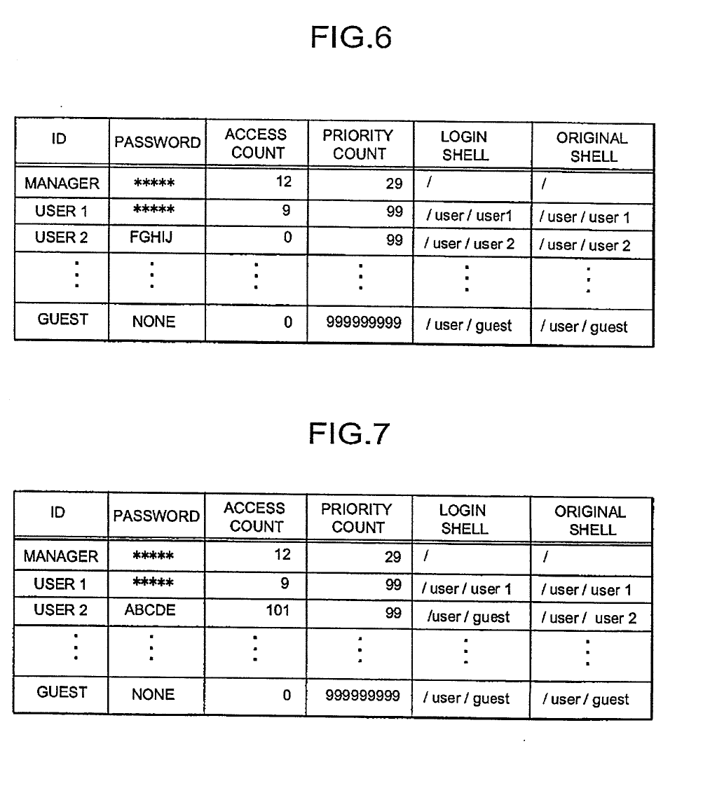

For example, when the user having the ID, User 2 registered in the ID table of FIG. 2 accesses the system 1, since the access count exceeds the priority count, the user is requested to change the password. If the user changes the password in response to the request, a new password will be registered as shown in FIG. 6. In this case, the access count is reset to zero.

On the other hand, if the user refuses to change the password, the access count will be incremented by one. In this case, the login shell is updated to the same one as for the guest, which forces the user to perform processing in a processing environment narrower in scope than the processing environment originally assigned to the user.

Even the user whose login shell has been changed to that of the guest is requested to change his or her password each time the user accesses the system 1. Therefore, the user can accede to the request at any time to recover the processing environment corresponding to the original shell.

After step S107, the access permission level control unit 14 notifies the environment providing control unit 12 of the login shell so that the environment providing control unit 12 will execute the login shell. Consequently, the user is allowed to use the apparatus group 13a or receive the distribution of software stored in the program storage unit 13b according to the access permission level controlled by the access permission level control unit 14.

The password can be changed not only when the access count exceeds the priority count, but also any time at the user's discretion. The access count in the ID table is reset to zero each time the password is changed.

In the first embodiment, the number of times the password is changed, corresponding to the number of accesses, is used as information for detecting the extent of user's interest and/or changes in the interest, but the information is not limited thereto. For example, the extent of user's interest and/or changes in the interest may be detected on the basis of how many hours (or days) have elapsed since the last access date or the date of changing (setting) the password. Further, ID tables may be so multiplexed that the extent of user's interest and/or changes in the interest are detected from the entire information.

Furthermore, if a variety of limits are settable in a processing environment, a variety of shells can be set accordingly.

<Second Embodiment>

Hereinbelow, an information providing system to which the present invention is applied will be described with reference to the accompanying drawings.

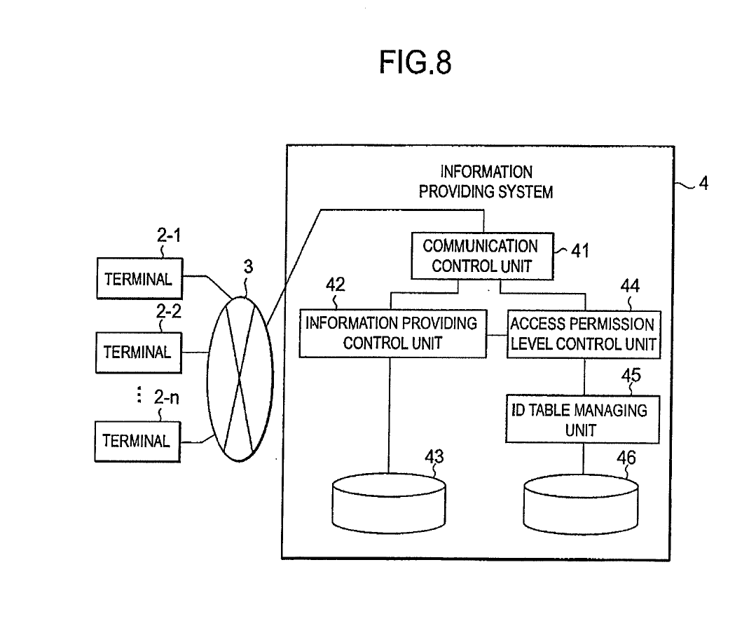

FIG. 8 shows a form of an information providing system 4 to which the present invention is applied. In this form, the information providing system 4 provides (distributes) information to an indefinite number of users through a network. As shown, the information providing system 4 is connected through the network 3 to terminals 2-1 to 2-n operated by the users (where n is a real number, and the suffix is omitted below), which enables two-way communication between the information providing system 4 and the terminals 2. It should be noted that since the terminals 2 and the network 3 are the same as those in the first embodiment, the same reference numerals are given thereto.

The information providing system 4 includes a communication control unit 41, an information providing control unit 42, a content database 43, an access permission level control unit 44, an ID table managing unit 45 and an ID database 46.

The communication control unit 41 controls the exchange of information with the terminals 2 through the network 3. In other words, the communication control unit 41 sends received information to the access permission level control unit 44 as required, and content data sent from the information providing control unit 42 to a desired terminal 2. The information providing control unit 42 reads content data from the content database 43 to send the same to the communication control unit 41. In this operation, the information providing control unit 42 receives a level of access permission defined for each user from the access permission level control unit 44. Then the information providing control unit 42 sends the communication control unit 41 only the content data that falls within the limits of the access permission level.

The content database 43 holds as digital content data used by the person operating and managing the information providing system 4 to attain the objectives of sales promotion and advertising of desired products. If the content data is information to be inserted in a home page on the Internet, it will be held in the content database 43 in a form which makes the content data displayed on the screen of the terminal 2 step by step according to the type or contents of each piece of information. To be more specific, the URL (uniform resource locators) indicative of the location of the information is held for the type or contents of each piece of information. The following assumes that the content data is digital data for a home page.

The access permission level control unit 44 controls the level of access permission indicative of limits of information available to each user according to the extent of user's interest in the products and relevant information held as the content data and/or changes in the interest. In the second embodiment, the level of access permission indicates a “priority level” to be described later. Further, the number of days elapsed after the last access date is used for detecting the extent of interest and/or changes in the interest.

The ID table managing unit 45 performs the reading and writing of data from and to an ID table stored in the ID database 46. The ID database 46 holds the ID table in which information such as a password, the last access date and the priority level is stored for each user.

Each terminal 2 may be a general-purpose computer, and the network 3 may be a switched network for establishing a connection between the terminal 2 and the information providing system 4.

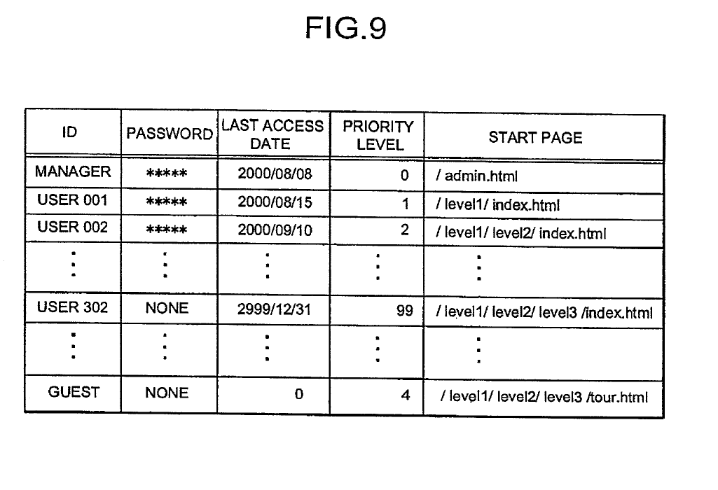

Referring next to FIG. 9, an example of the ID table stored in the ID database 46 will be described.

The term “ID” is information indicative of a manager, each user and a guest (nonmember) who gets first access to the home page. The “Password” is used for recognizing a corresponding ID; it can be set or changed on user's (member's) own initiative The “Last Access Date” indicates the date on which the user concerned got the last access to the system 4. When the user has accessed the system 4 only once, the first access data, that is, the data of registration is used as the last access date.

The “Priority Level” is an access permission level assigned to each user. In other words, limits of information available are defined according to the level. In the second embodiment, any one of five levels “0” to “4” is assigned to each user, where the level “0” is the widest limits of information and the levels that follow gradually narrow the limits of available information in ascending numeric order.

The “Start Page” is HTML representing a Web page the user who has logged in can visit first. In the second embodiment, each Web site has a common name. The page “tour.html” is to show a site map of the home page and an overview of the contents; it is presented as the first Web page for the guest user. The name “index.html” denotes the first Web page in each level, and the name “admin.html” denotes the Web page for the manager.

It should be noted that an ID “User 302” has no entry at present and default data are registered in sections corresponding to the columns headed “Password,” “Last Access Date,” “Priority Level,” and “Start Page.”

Description will be made next about processing for ID registration in the information providing system 4. The information providing system 4 performs processing to display a predetermined display screen on a terminal 2 in response to access from a user who makes a request for information.

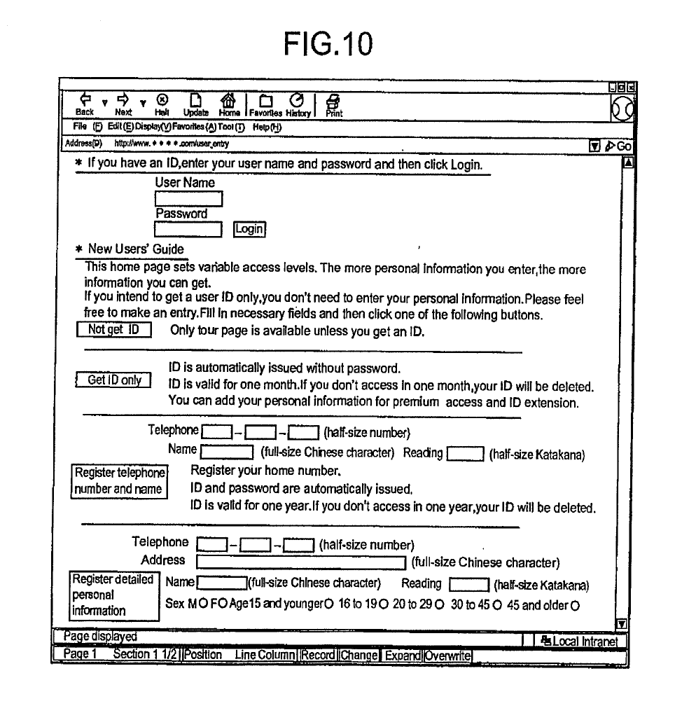

FIG. 10 shows an example of the screen to be displayed on the terminal 2. The screen is roughly divided into five areas. The topmost area is for users who already have IDs. The second area is for users who do not want to get IDs. If a user visits the home page from this area, the user is treated as a guest who receives information within the narrowest limits. The third area is for users who make a request for IDs but do not intend to be provided with information according to their own levels.

The remaining two areas are to get IDs, where one area is to enter user's name and telephone number, and the other area is to enter user's name, telephone number, address, sex and age.

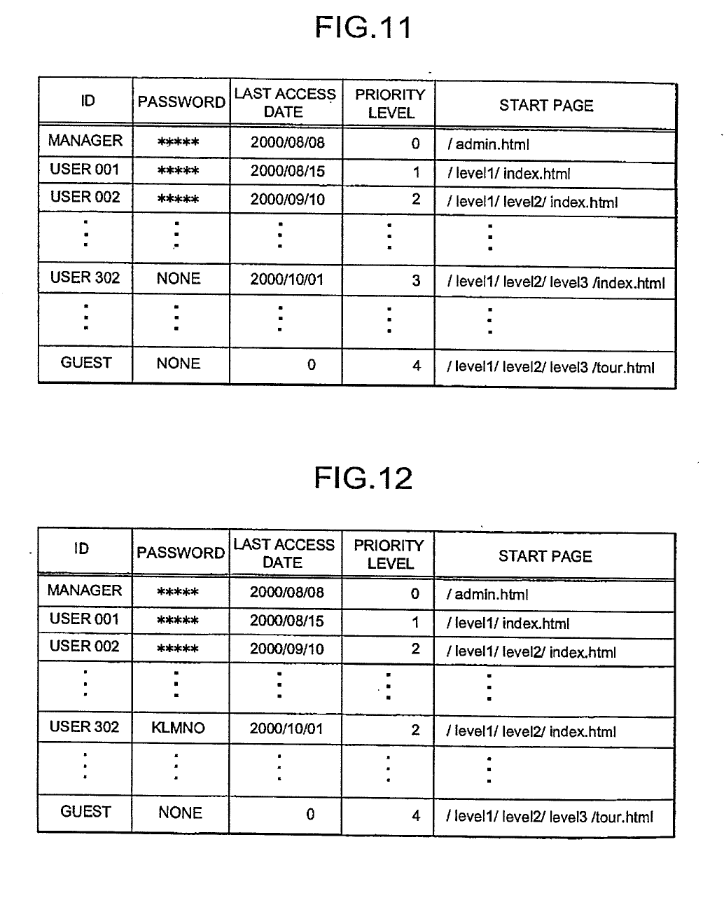

FIGS. 11 and 12 show examples of the ID table updated when a user gets an ID “User 302.” FIG. 11 shows a case where the user gets only the ID to make a request for the provision of information. Because the user gets only the ID, the ID “User 302” is given without the need to set a password. In this case, the priority level is 3, and the start page is “/level1/level2/level3/index.html.”

FIG. 12 shows a case where the user registers the name and telephone number to get an ID. In this case, a desired password is set, so that the priority level becomes 2 and the start page is “level1/level2/index.html.” In either case, the date of registration is registered as the last access date in the ID table.

The information such as the name and telephone number notified from the user is stored in a storage unit, not shown. The information may be so stored that the person operating and managing the information providing system 4 can use the information within such limits as not to intrude upon individual's privacy.

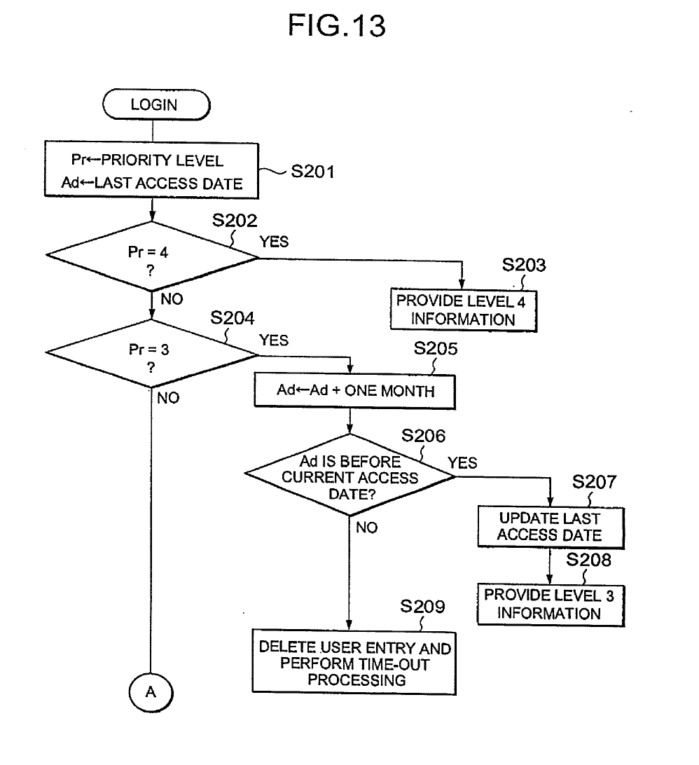

Referring next to FIGS. 13 to 15, description will be made about the operation of the information providing system 4 in response to access from a user who already has an ID or a user who does not want to get an ID.

Upon receipt of access from a user, the same screen as described in FIG. 10 is displayed on a terminal 2 operated by the user. If the user already has an ID, the user has only to enter the user name and password to log in. The ID and password entered on the terminal 2 are sent to the access permission level control unit 44 through the communication control unit 41. The user information control unit 42 acquires a password corresponding to the ID from the ID database 46 through the ID table managing unit 45 to perform authentication of the user who is operating the terminal 2.

If the accessing user is a user who does not want to get an ID or a user whose priority level is 3, since there is no need to enter a password, user authentication is omitted and the following processing step is executed.

If user authentication has been normally performed, the access permission level control unit 44 substitutes the registered priority level of the user and the last access date for variables Pr and Ad, respectively (step S201). At this time, the access permission level control unit 44 also reads the start page corresponding to the registered ID from the ID table.

Then the access permission level control unit 44 judges whether Pr is 4 (step S202). If Pr is 4 (YES in step S202), the priority level 4 and read-out start page are notified to the information providing control unit 42. The information providing control unit 42 performs processing for displaying the received start page on the terminal 2, and then provides content data held in the content database 43 according to the priority level (step S203). It should be noted that the priority level 4 is the narrowest limits of information that merely allows the user to browse the structure of the home page or a so-called tour page.

If Pr is not 4 (NO in step S202), the access permission level control unit 44 judges whether Pr is 3 (step S204). If Pr is 3 (YES in step S204), one month is added to Ad (step S205). The access permission level control unit 44 acquires the current date (the current access date) from a timer, not shown, to compare the same with Ad after one month has been added thereto (step S206).

If Ad is before the current access date, that is, when less than one month has elapsed since the last access YES in step S206), the access permission level control unit 44 updates the last access date in the ID table to the current access date (Year/Month/Day) (step S207). After that, the priority level 3 and the read-out start page are notified to the information providing control unit 42. The information providing control unit 42 performs processing for displaying the received start page on the terminal 2, and then provides content data held in the content database 43 according to the priority level (step S208).

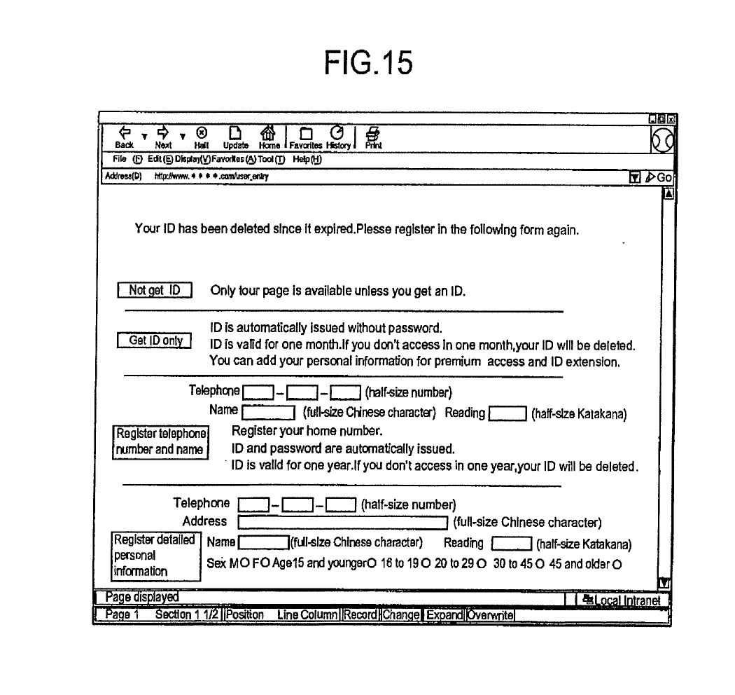

If Ad is the same as or past the current access date, that is, when one month or more have elapsed since the last access (NO in step S206), the access permission level control unit 44 deletes the user information registered in the ID table and performs predetermined time-out processing (step S209). The time-out processing includes processing for displaying on the terminal 2 a screen as shown in FIG. 15. The screen shown is to inform the user that the ID has expired and is now invalid. The time-out processing helps the user get an ID again according to the instructions on the screen or browse the home page as a guest. Therefore, the user whose registered ID is deleted can enter his or her own information again to get a new ID. In this case, the contents (level) of information to be entered can also be changed to get an ID for a priority level different from that assigned last time. Further, the user who does not want to get an ID can request the information providing system 4 to provide information for the guest.

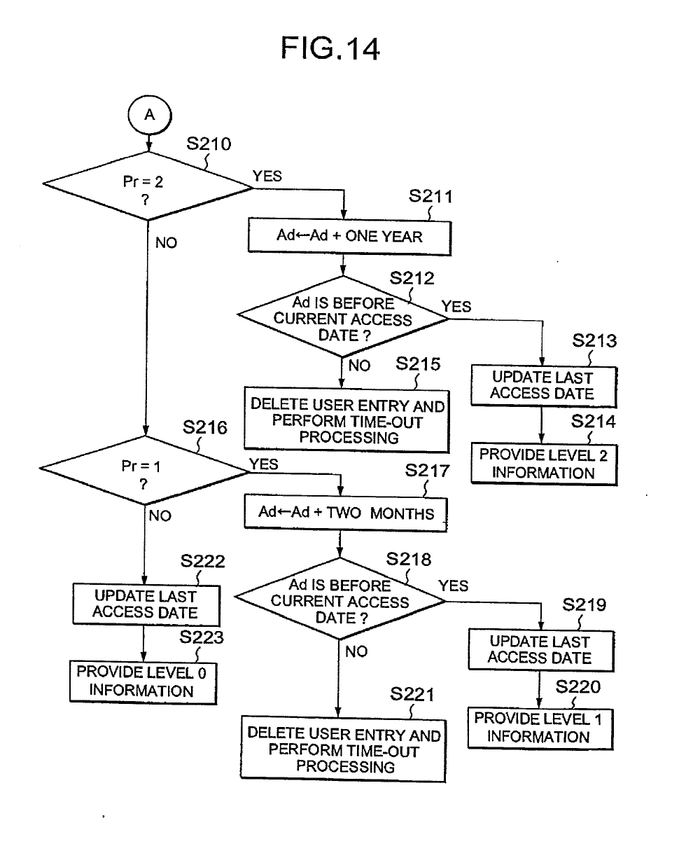

If Pr is not 3 (NO in step S204), the access permission level control unit 44 judges whether Pr is 2 (step S210 in FIG. 14). If Pr is 2 (YES in step S210), one year is added to Ad (step S211). The access permission level control unit 44 acquires the current date (current access date) from the timer, not shown, to compare the same with Ad after one year has been added thereto (step S212).

If Ad is before the current access date, that is, when less than one year has elapsed since the last access (YES in step S212), the access permission level control unit 44 updates the last access date in the ID table to the current access date (Year/Month/Day) (step S213). After that, the priority level 2 and the read-out start page are notified to the information providing control unit 42. The information providing control unit 42 performs processing for displaying the received start page on the terminal 2, and then provides content data held in the content database 43 according to the priority level (step S214).

If Ad is the same as or past the current access date, that is, when one year or more have elapsed since the last access (NO in step S212), the access permission level control unit 44 deletes the user information registered in the ID table and performs predetermined time-out processing (step S215). The time-out processing is the same processing as mentioned in step S209 and description thereof is omitted.

If Pr is not 2 (NO in step S210), the access permission level control unit 44 judges whether Pr is 1 (step S216). If Pr is 1 (YES in step S216), two years are added to Ad (step S217). The access permission level control unit 44 acquires the current date (current access date) from the timer, not shown, to compare the same with Ad after two years have been added thereto (step S218).

If Ad is before the current access date, that is, when less than two years have elapsed since the last access (YES in step S218), the access permission level control unit 44 updates the last access date in the ID table to the current access date (Year/Month/Day) (step S219). After that, the priority level 1 and the read-out start page are notified to the information providing control unit 42. The information providing control unit 42 performs processing for displaying the received start page on the terminal 2, and then provides content data held in the content database 43 according to the priority level (step S220).

If Ad is the same as or past the current access date, that is, when two years or more have elapsed since the last access (NO in step S218), the access permission level control unit 44 deletes the user information registered in the ID table and performs predetermined time-out processing (step S221). The time-out processing is the same processing as mentioned in step S209 and description thereof is omitted.

If Pr is not 1 (NO in step S216), the access permission level control unit 44 judges that the accessing user is the manager assigned the priority level 0, and then updates the access date corresponding to the manager in the ID table to the current access date (step S222). After that, the priority level 0 and the read-out start page are notified to the information providing control unit 42. The information providing control unit 42 performs processing for displaying the received start page on the terminal 2, and then provides content data held in the content database 43 according to the priority level (step S223).

The above-mentioned processing steps allow the system 4 to provide information within the limits of the priority level. Particularly, in the second embodiment, a priority level for defining limits of information available is set according to the contents of user's personal information to be entered in the information providing system 4 at the time of ID registration. This allows the person operating and managing the information providing system 4 to determine how much interest the registered user takes.

Further, it is detected how the interest has been changing, which can also be used to determine the personal information obtained from the user or information to be provided to the user. In other words, decreasing interest in the information to be provided makes the interval between accesses longer. Therefore, if many users become infrequent visitors, the information provided to the users as content data may be reviewed and revised upward.

A certain interval may also be set for each priority level. In this case, when the interval between accesses exceeds the set interval, the user's interest is regarded as decreasing, thereby deleting the registered information from the ID table. Thus the registered information is deleted from the ID table when the user's interest in the information provided is lowered to a predetermined extent, which makes it possible to manage only the information on desired users. Any user whose registration has been deleted, however, can register again (get ID again), which allows the user to be provided with information after his or her interest has been lowered.

In the second embodiment, the state of access from each user triggers a deletion of information from the ID table, but the present invention is not limited thereto. For example, such a timer as to tell elapsed time periodically may be used to delete information at regular intervals regardless of the presence or absence of access.

As discussed in the first and second embodiments and according to the present invention, the extent of user's interest in the processing environment or information to be provided and/or changes in the interest are quantified. The use of the quantified information makes it possible to control information for defining limits of a processing environment or information available to each user, which allows a good user to get a processing environment or information appropriate to the user.

In the first embodiment, the “shell” is used as the access permission level, the “number of times the password is changed” is used as information to detect the extent of interest and/or changes in the interest, and the “processing environment” is used as a target to be provided to each user. In the second embodiment, the “priority level,” the “number of days that have elapsed since the last access date,” and the “information” are used instead. However, the criteria or targets are not limited to those in the above-mentioned embodiments. The combination of the criteria or targets may be changed or altered, or used in common.

Further, the extent of interest and/or changes in the interest may be quantified on the basis of the number of times each user is logged in, duration after registration (for example, the duration of membership when the user has signed up for membership), or the number of points given for user's activities such as to introduce other users. In the last case, a number of points to be given may be set in advance according to the contents of each user's activity, which makes it possible to effectively quantify the extent of user's interest and/or changes in the interest. Further, the points given may be cumulatively added up, or subtracted from a predetermined number of points. In this case, a column for recording the results of addition or subtraction of these points needs to be provided in the ID table in the above-mentioned embodiments.

Furthermore, information for defining limits of a processing environment or information to be provided to each user according to the quantified information on the extent of user's interest and/or changes in the interest, that is, a level of access permission may be controlled according to other factors.

For example, the level of access permission may be so controlled that a user who is treated as a member after having signed up may be provided with a beginner's processing environment or information for a fixed period of time after the user became a member. Alternatively, a special processing environment or information may be provided before and after a predetermined period of time has elapsed since registration. For example, if the target object is information inserted in a home page, a premium page for the second year may be made available to a member after one year has elapsed since the user earned membership. Further, if a user enters information related to a specific date such as user's birthday at the time of registration, the level of access permission may be so changed that a special processing environment or information is provided on or before and after the day.

According to the present invention, there is provided a technique for providing a processing environment or information within limits of information appropriate to each user. In particular, according to the present invention, there is provided an apparatus and method in which plural levels of access permission that define limits of information or processing environments available are controlled properly for each user.

Various embodiments and changes may be made thereunto without departing from the broad spirit and scope of the invention. The above-described embodiments intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A method of controlling levels of access permission, implemented in a system in which any of plural levels of access permission that define limits of information available is assigned to each user so that when a user authorized to have access makes a request for the access, the user is permitted to access information within the limits of the access permission level, said method comprising the steps of:
detecting, on the basis of user's history of access requests, the extent of user's interest in the information to be provided and/or changes in the interest; and
allowing the level of access permission currently assigned to the user to be changed to another level according to the detected extent of user's interest and/or changes in the interest.

2. The method according to claim 1, further comprising the steps of:
holding identification information settable by each user for identifying the user; and
asking the user as the source of an access request to input the identification information so as to define such a permission condition that the user is normally identified using the identification information, wherein said detection step has detection of the extent of user's interest and/or changes in the interest on the basis of user's history after the last setting of the identification information.

3. The method according to claim 2, further comprising the step of asking the user as the source of the access request to update the identification information when the detected extent of user's interest and/or changes in the interest meet predetermined conditions.

4. The method according to claim 3, further comprising the step of changing the level of access permission currently assigned to the user as the source of the access request to a level narrower in scope than that defined by the current level when the identification information has not been updated.

5. The method according to claim 2, further comprising the step of asking the user as the source of the access request to update the identification information when the detected extent of user's interest and/or changes in the interest show that the number of times access is requested exceeds a predetermined number of times.

6. The method according to claim 5, further comprising the step of changing the level of access permission currently assigned to the user as the source of the access request to a level narrower in scope than that defined by the current level when the identification information has not been updated.

7. The method according to any one of claim 1, further comprising the steps of:
assigning each user, in exchange for entries of information related to the user, identification information for identifying the user and a level of access permission defined according to the contents of the information entered; and
asking the user as the source of an access request to input the identification information assigned so as to define an access condition that the user is normally identified using the input identification information, wherein
said detection step has detection of the extent of user's interest and/or changes in the interest on the basis of user's history after the last setting of the identification information.

8. The method according to claim 7, further comprising the step of asking the user as the source of the access request to enter user's information again when the detected extent of user's interest and/or changes in the interest meet predetermined conditions.

9. The method according to claim 8, further comprising the step of changing the level of access permission currently assigned to the user as the source of the access request to a level narrower in scope than that defined by the current level when the user has not entered user's information in response to said step of asking the user to enter the information again.

10. The method according to claim 8, further comprising the step of deleting the identification information assigned to the user when the user has not entered user's information in response to said step of asking the user to enter the information again.

11. The method according to claim 7, further comprising the step of asking the user as the source of the access request to enter user's information again when the detection result of the extent of user's interest and/or changes in the interest show that a predetermined number of days have elapsed since the last access request.

12. The method according to claim 11, further comprising the step of changing the level of access permission currently assigned to the user as the source of the access request to a level narrower in scope than that defined by the current level when the user has not entered user's information in response to said step of urging the user to enter the information again.

13. The method according to claim 11, further comprising the step of deleting the identification information assigned to the user when the user has not entered user's information in response to said step of asking the user to enter the information again.

14. A method of controlling levels of access permission, implemented in a system in which any of plural levels of access permission that define limits of one or more apparatuses available is assigned to each user so that when a user authorized to have access makes a request for the access, the user is permitted to use the one or more apparatuses within the limits of the access permission level, said method comprising the steps of:
detecting, on the basis of user's history of access requests, the extent of user's interest in the one or more apparatuses to be used and/or changes in the interest; and
allowing the level of access permission currently assigned to the user to be changed to another level according to the detected extent of user's interest and/or changes in the interest.

15. A method of controlling levels of access permission, implemented in a computer system for providing digital information to add a processing function as needed to a terminal operated by a user, in which any of plural levels of access permission that define limits of digital information accessible is assigned to each user so that when a user authorized to have access makes a request for the access, the user is permitted to access the digital information within the limits of the access permission level, said method comprising the steps of:
detecting, on the basis of user's history of access requests, the extent of user's interest in the digital information to be provided and/or changes in the interest; and
allowing the level of access permission currently assigned to the user to be changed to another level according to the detected extent of user's interest and/or changes in the interest.

16. An apparatus for controlling levels of access permission, applied to a computer system in which any of plural levels of access permission that define limits of information available is assigned to each user so that when a user authorized to have access makes a request for the access, the user is permitted to access information within the limits of the access permission level, said apparatus comprising: means for monitoring, on the basis of user's history of access requests, the extent of user's interest in the information to be provided and/or changes in the interest; and
means for allowing the level of access permission currently assigned to the user to be changed to another level according to the detected extent of user's interest and/or changes in the interest.

17. An apparatus for controlling levels of access permission, applied to a computer system in which any of plural levels of access permission that define limits of one or more apparatuses available is assigned to each user so that when a user authorized to have access makes a request for the access, the user is permitted to use the one or more apparatuses within the limits of the access permission level, said apparatus comprising: means for monitoring, on the basis of user's history of access requests, the extent of user's interest in the one or more apparatuses to be used and/or changes in the interest; and
means for allowing the level of access permission currently assigned to the user to be changed to another level according to the detected extent of user's interest and/or changes in the interest.

18. An apparatus for controlling levels of access permission, applied to a computer system for providing digital information to add a processing function as needed to a terminal operated by a user, in which any of plural levels of access permission that define limits of digital information available is assigned to each user so that when a user authorized to have access makes a request for the access, the user is permitted to access the digital information within the limits of the access permission level, said apparatus comprising: means for monitoring, on the basis of user's history of access requests, the extent of user's interest in the digital information to be provided and/or changes in the interest; and
means for allowing the level of access permission currently assigned to the user to be changed to another level according to the detected extent of user's interest and/or changes in the interest.
